(19) United States
(12) Patent Application Publication
(10) Pub. No.: US 2006/0132470 A1
(43) Pub. Date: Jun. 22, 2006

(54) Overdrive method for anti-double edge

(75) Inventors: Han-Jon Ho, Kaohsiung (TW); Chun-Chi Chen, Kaohsiung City (TW)

Correspondence Address: DENNISON, SCHULTZ, DOUGHERTY;& MACDONALD, SUITE 105, 1727 KING STREET, ALEXANDRIA, VA, 22314-2700, US

(73) Assignee: VASTVIEW TECHNOLOGY INC.

(21) Appl. No.: 11/014,841

(22) Filed: Dec. 20, 2004

(51) Int. Cl. G09G 5/00

(52) U.S. Cl. 345/204

(57) ABSTRACT

An overdrive method for anti-double edge uses: a register unit, a signal processing module including a selection unit and a driving-voltage lookup table (ADE LUT) and a plurality of multiplex processing units to effectively save the resources of hardware and to eliminate the double edge phenomenon generated during overdrive liquid-crystal image developing by selecting among present frame driving-voltage values, overdrive voltage values and practically-obtained voltage values input from the driving-voltage lookup table and by outputting driving-voltage values suitable for respective situations according to selection signals of a selection unit by the multiplex processing units. The method is added with a complementary table and an operation unit to increase its scope of application, to eliminate double edge generated by different reaction speeds; and thereby is suitable for various liquid crystal displays.

### BACKGROUND OF THE INVENTION

1. Field of the Invention

The present invention is related to an overdrive method for anti-double edge, and especially to an overdrive method which can effectively eliminate double edge phenomenon generated during overdrive liquid-crystal image developing by selection from an ADE (anti-double edge) Lookup Table (LUT) containing therein present frame driving-voltage values, overdrive voltage values and practically-obtained voltage values. By adding a complementary table and an operation unit, the method can eliminate double edge phenomenon generated because of different reaction speeds; and thereby is suitable for various liquid crystal displays.

2. Description of the Prior Art

The liquid crystal display device allows obtaining a highly precise display. However, since the LCD does not have a sufficient image quality in displaying a moving pictures, so that there is an index—response time to discriminate being good or bad of the performance of a liquid crystal display. Generally, liquid crystal displays are divided into two kinds when being not added with voltage: Normally White (NW) mode, and Normally Black (NB) mode; wherein the Normally White mode means that a display panel has a transparent frame when being not added with voltage, that is a bright frame; the Normally Black mode means that a display panel has an obscure state when being not added with voltage, that is a black frame. Taking the Normally White mode as an example, the response time is divided into two parts:
(1) ascending response time: this is the twist time required for liquid crystal to make the brightness of a liquid crystal box of a liquid crystal display to change from 90% to 10%, and is called “Tᵣ” under adding with voltage; and
(2) descending response time: this is the restoring time required for the liquid crystal to make the brightness of the liquid crystal to change from 10% to 90%, and is called “T_{f}” when being not added with voltage.

Generally, when the speed of developing of pictures exceeds 25 pieces/sec., the eyes of a person will take the pictures changing fast as continuous pictures; while in modern family amusements, such as in playing a high-quality DVD movie, the speed of developing the fast moving pictures normally is larger than 60 frames/sec. In other words, the time interval of each frame is 1/60=16.67 ms; if the response time of a liquid crystal display is larger than the frame interval, it will induce traces of residual images or tabs to seriously affect the qualities of images observed. It should be viewed from the factors affecting the response time to know how to increase the speed of response. The following equations are respectively the calculating equations for the ascending response time Tᵣ and the descending response time T_{f}:

$${T}_{r} = \frac{{γ}_{1} {d}^{2}}{Δ ɛ ( {V}^{2} - {V}_{th}^{2} )}$$

$${T}_{f} = \frac{{γ}_{1} {d}^{2}}{Δ ɛ {V}_{th}^{2} )}$$

Wherein
γ₁: the viscosity coefficient of the liquid crystal;
V: the driving voltage of the liquid crystal box;
Δε: the dielectric coefficient of the liquid crystal.

It can be known from the above statement that there are four ways to reduce the response time of the liquid crystal display: to lower the viscosity coefficient of the liquid crystal, to reduce gaps of the liquid crystal box, to increase the driving voltage and to increase the dielectric coefficient, wherein the technique to increase the driving voltage is called an “overdrive” technique, the increased voltage can be transferred by a liquid-crystal driver IC to a liquid crystal panel to increase the twist voltage of the liquid crystal, and thereby the liquid crystal can twist and restore faster to rapidly get the brightness of the image data to be presented.

When the overdrive voltage value of a conventional overdrive technique is getting close to a maximum value (code 255) and a minimum value (code 0), it is unable to render a liquid crystal to twist smoothly within the time interval of a frame to get an object value; as is shown in FIG. 7, an overdrive voltage value is added within the time interval of a first frame in order to get an object value of the driving voltage of a present frame, however the practically-obtained voltage value is inferior; then another overdrive voltage value is added within the time interval of a second frame in order to get an object value of the driving voltage of a present frame, but rather, the error of the first frame renders the practically-obtained voltage value to exceed the object value. Such error renders the liquid crystal panel to get a situation of being much brighter or darker than the bottom color during displaying of the liquid crystal panel; such situation is called “Double Edge”.

In order to get rid of the phenomenon of Double Edge created by the nature of liquid crystal in the conventional overdrive technique, big manufacturers in the art has proposed several solving countermeasures presently. However, the solving measures known presently all use two lookup tables having therein overdrive codes (voltage values) and practically-obtained voltage values of liquid crystal to respectively execute access, and then to make comparison of frame data of a former frame temporarily stored in a frame register with frame data of a present frame coming from an input source, thus an overdrive code can be obtained and output.

By virtue that these operations all need the two lookup tables, while a lookup table also means that it needs two times of resource space for a memory, this forms an extremely heavy burden for a display with an extremely limited resource space for the memory. And more, it is the common tendency in the art of liquid crystal panels to increase speeds of reactions; while at such faster speeds of reactions, corresponding contrast data are required for their double edge phenomenon.

In view of the above conventional defects to be solved for providing a new countermeasure to solve the phenomenon of Double Edge for singular reaction speeds and different reaction speeds only with an anti-double edge lookup table (ADE LUT), the inventor provides the present invention based on his practical professional experience of industry in academic studying, designing and improvements.

### SUMMARY OF THE INVENTION

The primary objective of the present invention is to provide an overdrive method to effectively save the resources of hardware and to eliminate the double edge phenomenon generated during overdrive liquid-crystal image developing by selecting respectively among present frame driving-voltage values, overdrive voltage values and practically-obtained voltage values input from a driving-voltage lookup table and by outputting driving-voltage values suitable for respective situations according to selection signals of selection units by a plurality of multiplex processing units.

The secondary objective of the present invention is to provide an overdrive method using a complementary table and an operation unit, the method can effectively save the resources of hardware and to eliminate the double edge phenomenon generated at different reaction speeds by selecting respectively among present frame driving-voltage values, overdrive voltage values and practically-obtained voltage values input from a driving-voltage lookup table and by outputting driving-voltage values suitable for respective situations according to selection signals of a selection unit by a plurality of multiplex processing units.

Therefore, in order to achieve the above stated primary objective, the overdrive method for anti-double edge of the present invention comprises using: a register unit, a signal processing module including a selection unit and a driving-voltage lookup table (ADE LUT); two ordinate axes of the driving-voltage lookup table represent the values of driving voltages of the present frame and the values of driving voltages of a former frame. The driving-voltage lookup table has therein a first, a second, a third and a fourth area, they respectively contain some of and are provided for the followings: the values of driving voltages of a former frame, the values of driving voltages of the present frame, overdrive voltage values and practically-obtained voltage values, a first multiplex processing unit and a second multiplex processing unit.

The steps of processing include:
(1) a value of driving voltage of the present frame is input;
(2) the signal processing module receives a value of driving voltage of the former frame and a value of driving voltage of the present frame, the former frame is the frame just before the present frame in relation to point of time;
(3) the value of driving voltage of the present frame and the value of driving voltage of the former frame mentioned above are under selection of the selection unit for outputting a selection signal, the selection signal represents one of the first to fourth areas, the value of driving voltage of the present frame and the value of driving voltage of the former frame pass through the driving-voltage lookup table for outputting one of the value of driving voltage of the present frame, an overdrive voltage value and a practically-obtained voltage value;
(4) the first multiplex processing unit receives the selection signal, the value of driving voltage of the present frame, the overdrive voltage value, the minimum overdrive voltage value and the maximum overdrive voltage value to thereby output one of the value of driving voltage of the present frame, the overdrive voltage value, the minimum overdrive voltage value and the maximum overdrive voltage value according to the selection signal; the second multiplex processing unit receives one of the selection signal, the value of driving voltage of the present frame, the overdrive voltage value and the practically-obtained voltage value to thereby output one of the value of driving voltage of the present frame and the practically-obtained voltage value according to selection of the selection signal; and
(5) the register unit stores one of the value of driving voltage of the present frame and the practically-obtained voltage value output from the second multiplex processing unit, and takes the output as the value of driving voltage of the former frame of the next point of time to output to the signal processing module.

Thereby, to give one of the value of driving voltage of the present frame, the overdrive voltage value, the minimum overdrive voltage value and the maximum overdrive voltage value in pursuance of the requirement of the respectively one of different driving voltages of frames; the double edge phenomenon generated during liquid-crystal image developing can be effectively gotten rid of, so that a liquid crystal display can display in a fast and accurate mode.

And thereby, in order to achieve the above stated secondary objective, the overdrive anti-double edge method of the present invention comprises using: a complementary table and an operation unit; the value of driving voltage of the present frame and the value of driving voltage of the former frame pass through the driving-voltage lookup table for outputting a voltage complementary value, the operation unit does operation with the voltage complementary value for the value of driving voltage of the present frame, then it obtains the voltage value having been complemented; the first multiplex processing unit receives the selection signal, the value of driving voltage of the present frame, the minimum overdrive voltage value and the maximum overdrive voltage value to thereby select to output one of the value of driving voltage of the present frame, the minimum overdrive voltage value and the maximum overdrive voltage value according to the selection signal; the second multiplex processing unit receives the selection signal, the value of driving voltage of the present frame, the voltage value having been complemented and the practically-obtained voltage value to thereby select to output one of the value of driving voltage of the present frame and the practically-obtained voltage value.

Accordingly, to give one of the value of driving voltage of the present frame, the overdrive voltage value, the minimum overdrive voltage value and the maximum overdrive voltage value in pursuance of the requirement of the respectively one of different driving voltages of frames, the double edge phenomenon generated at different reaction speeds can be effectively gotten rid of, so that a liquid crystal display can display in a fast and accurate mode.

The present invention will be apparent after reading the detailed description of the preferred embodiment thereof in reference to the accompanying drawings.

### BRIEF DESCRIPTION OF THE DRAWINGS

FIG. 1 is a schematic view showing the arrangement of a first embodiment of the present invention;

FIG. 2 depicts a curvilinear figure showing the allocating areas of a driving-voltage lookup table (ADE LUT) of the first embodiment of the present invention;

FIG. 3A shows a step of a first case of the first embodiment of the present invention;

FIG. 3B shows a step of a second case of the first embodiment of the present invention;

FIG. 3C shows a step of a third case of the first embodiment of the present invention;

FIG. 3D shows a step of a fourth case of the first embodiment of the present invention;

FIG. 4 is a schematic view showing the arrangement of a second embodiment of the present invention;

FIG. 5 depicts a curvilinear figure showing the allocating areas of a driving-voltage lookup table (ADE LUT) of the second embodiment of the present invention;

FIG. 6A shows a step of a first case of the second embodiment of the present invention;

FIG. 6B shows a step of a second case of the second embodiment of the present invention;

FIG. 6C shows a step of a third case of the second embodiment of the present invention;

FIG. 6D shows a step of a fourth case of the second embodiment of the present invention;

FIG. 6E shows a step of a fifth case of the second embodiment of the present invention; and

FIG. 7 is a schematic view showing the double edge phenomenon of the conventional overdrive technique.

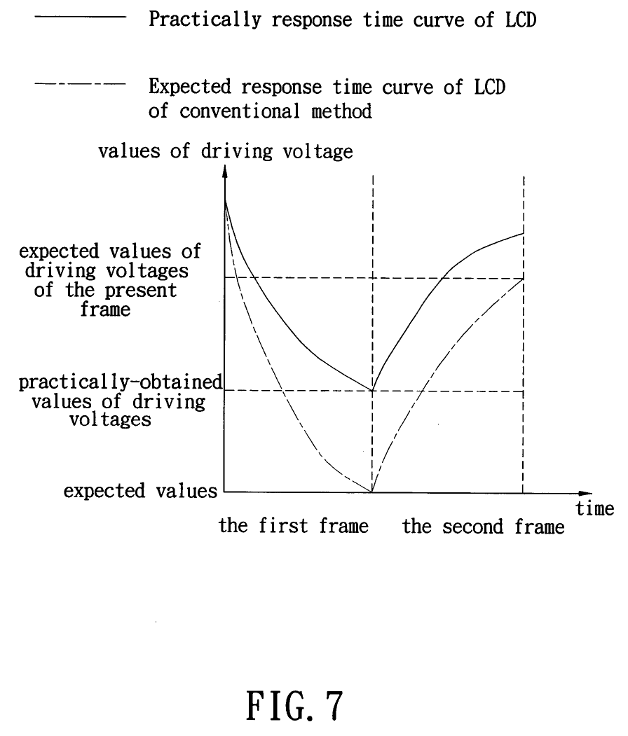

### DETAILED DESCRIPTION OF THE PREFERRED EMBODIMENT

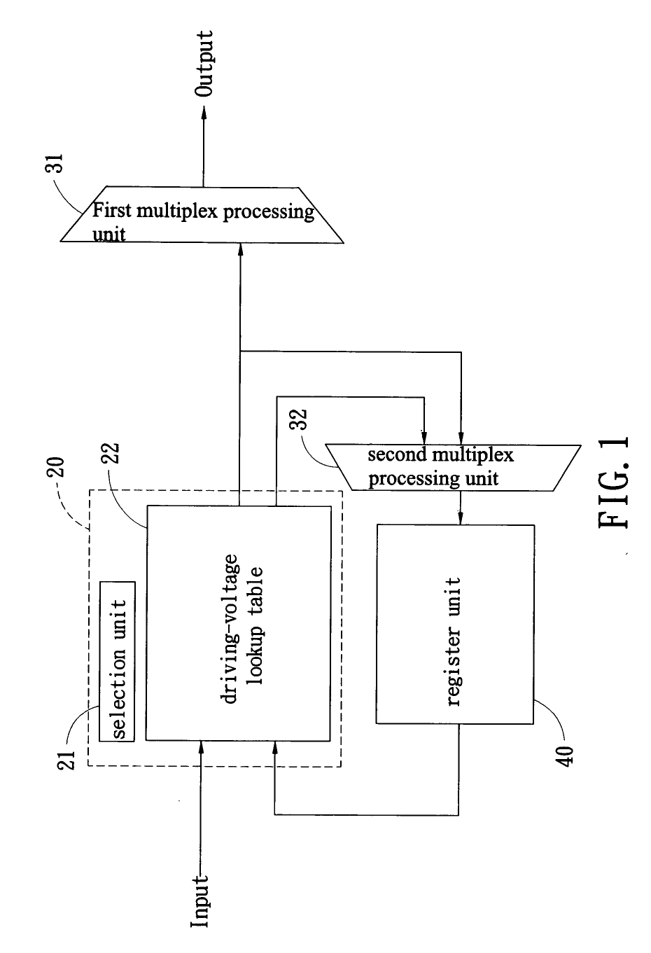

Referring to FIG. 1, the first embodiment of the overdrive method of the present invention is applied to a reaction speed of 16 ms, and includes using: a signal processing module 20 having a selection unit 21 and a driving-voltage lookup table (anti-double edge Lookup Table, namely, ADE LUT) 22, a first multiplex processing unit 31 and a second multiplex processing unit 32 to receive selection signals from the selection unit 21 and values of driving voltages from the driving-voltage lookup table 22, and a register unit 40.

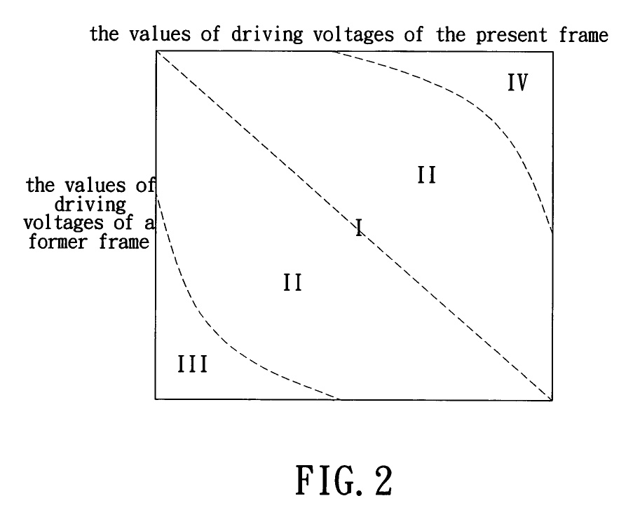

As shown in FIG. 2, two ordinate axes of the driving-voltage lookup table 22 represent the values of driving voltages of the present frame and the values of driving voltages of a former frame. The driving-voltage lookup table 22 has therein a first, a second, a third and a fourth area I, II, III, IV respectively for the values of driving voltages of a former frame and the values of driving voltages of the present frame, the first area I contains the values of driving voltages of the present frame, the second area II contains overdrive voltage values, while the third and the fourth areas III, IV contain practically-obtained voltage values.

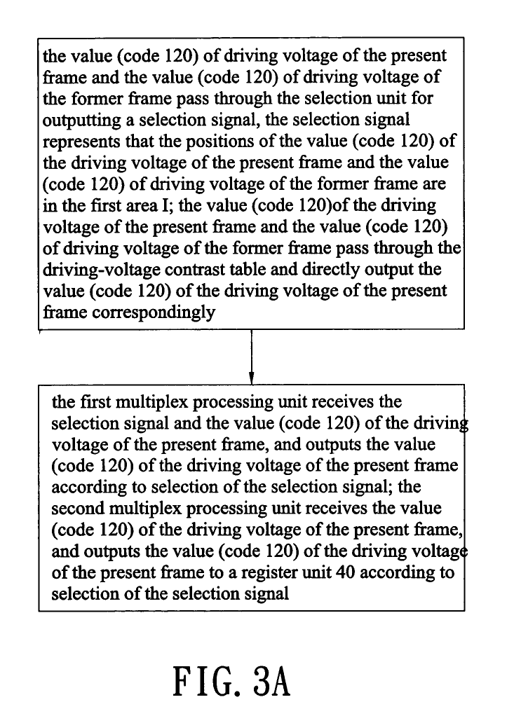

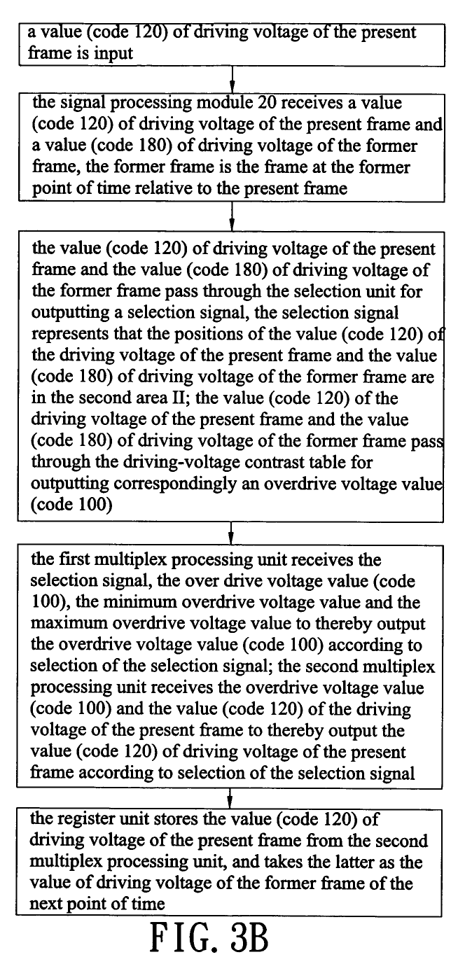

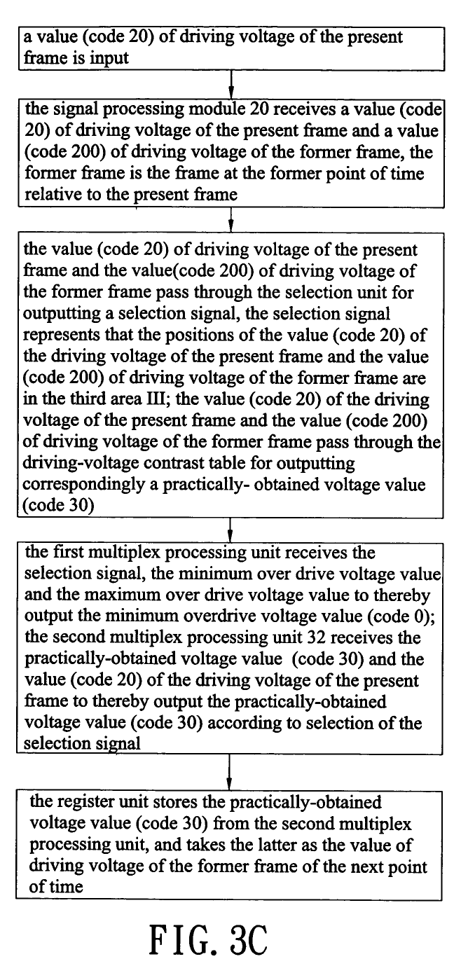

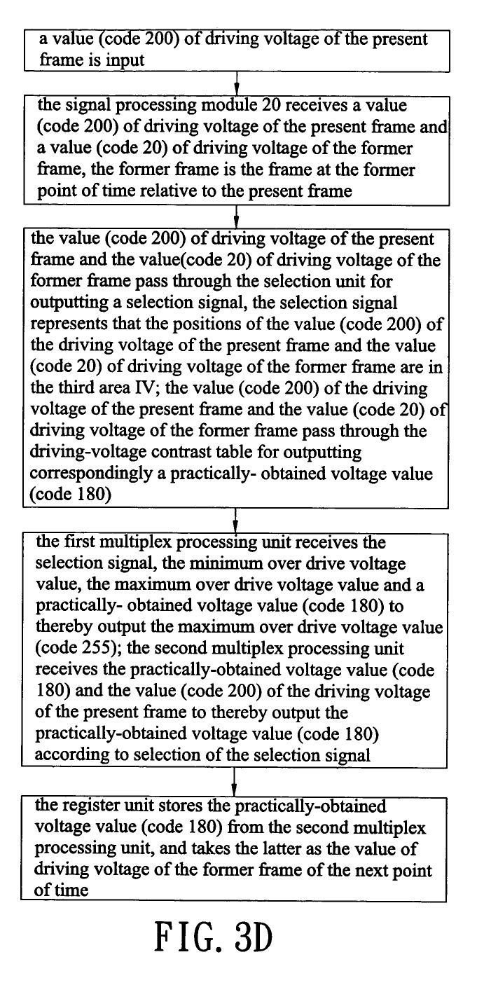

The steps of processing of the overdrive method of the present invention include those shown in FIGS. 3A-3D, and include four cases:

The first case designates a code 120 (value) of driving voltage of a former frame and a code 120 (value) of driving voltage of the present frame:
(1) the value (code 120) of driving voltage of the present frame and the value (code 120) of driving voltage of the former frame pass through the selection unit 21 for outputting a selection signal, the selection signal represents that the positions of the value (code 120) of the driving voltage of the present frame and the value (code 120) of driving voltage of the former frame are in the first area I; the value (code 120) of the driving voltage of the present frame and the value (code 120) of driving voltage of the former frame pass through the driving-voltage lookup table 22 and directly output the value (code 120) of the driving voltage of the present frame;

(2) the first multiplex processing unit 31 receives the selection signal and the value (code 120) of the driving voltage of the present frame, and outputs the value (code 120) of the driving voltage of the present frame according to selection of the selection signal; the second multiplex processing unit 32 receives the value (code 120) of the driving voltage of the present frame, and outputs the value (code 120) of the driving voltage of the present frame to a register unit 40 according to selection of the selection signal. The second case designates a value (code 180) of driving voltage of a former frame and a value (code 120) of driving voltage of the present frame:
(1) a value (code 120) of driving voltage of the present frame is input;
(2) the signal processing module 20 receives a value (code 120) of driving voltage of the present frame and a value (code 180) of driving voltage of the former frame, the former frame is the frame at the former point of time relative to the present frame;
(3) the value (code 120) of driving voltage of the present frame and the value (code 180) of driving voltage of the former frame pass through the selection unit 21 for outputting a selection signal, the selection signal represents that the positions of the value (code 120) of the driving voltage of the present frame and the value (code 180) of driving voltage of the former frame are in the second area II; the value (code 120) of the driving voltage of the present frame and the value (code 180) of driving voltage of the former frame pass through the driving-voltage lookup table 22 for outputting correspondingly an overdrive voltage value (code 100);
(4) the first multiplex processing unit 31 receives the selection signal, the overdrive voltage value (code 100), the minimum overdrive voltage value and the maximum overdrive voltage value to thereby output the overdrive voltage value (code 100) according to selection of the selection signal; the second multiplex processing unit 32 receives the overdrive voltage value (code 100) and the value (code 120) of the driving voltage of the present frame to thereby output the value (code 120) of driving voltage of the present frame according to selection of the selection signal; and
(5) the register unit 40 stores the value (code 120) of driving voltage of the present frame from the second multiplex processing unit 32, and takes the latter as the value of driving voltage of the former frame of the next point of time.

The third case designates a value (code 200) of driving voltage of a former frame and a value (code 20) of driving voltage of the present frame:
(1) a value (code 20) of driving voltage of the present frame is input;
(2) the signal processing module 20 receives a value (code 20) of driving voltage of the present frame and a value (code 200) of driving voltage of the former frame, the former frame is the frame at the former point of time relative to the present frame;
(3) the value (code 20) of driving voltage of the present frame and the value (code 200) of driving voltage of the former frame pass through the selection unit 21 for outputting a selection signal, the selection signal represents that the positions of the value (code 20) of the driving voltage of the present frame and the value (code 200) of driving voltage of the former frame are in the third area III; the value (code 20) of the driving voltage of the present frame and the value (code 200) of driving voltage of the former frame pass through the driving-voltage lookup table 22 for outputting correspondingly a practically-obtained voltage value (code 30);
(4) the first multiplex processing unit 31 receives the selection signal, the minimum overdrive voltage value and the maximum overdrive voltage value to thereby output the minimum overdrive voltage value (code 0); the second multiplex processing unit 32 receives the practically-obtained voltage value (code 30) and the value (code 20) of the driving voltage of the present frame to thereby output the practically-obtained voltage value (code 30) according to selection of the selection signal;
(5) the register unit 40 stores the practically-obtained voltage value (code 30) from the second multiplex processing unit 32, and takes the latter as the value of driving voltage of the former frame of the next point of time.

The fourth case designates a value (code 20) of driving voltage of a former frame and a value (code 200) of driving voltage of the present frame:
(1) a value (code 200) of driving voltage of the present frame is input;
(2) the signal processing module 20 receives a value (code 200) of driving voltage of the present frame and a value (code 20) of driving voltage of the former frame, the former frame is the frame at the former point of time relative to the present frame;
(3) the value (code 200) of driving voltage of the present frame and the value (code 20) of driving voltage of the former frame pass through the selection unit 21 for outputting a selection signal, the selection signal represents that the positions of the value (code 200) of the driving voltage of the present frame and the value (code 20) of driving voltage of the former frame are in the third area IV; the value (code 200) of the driving voltage of the present frame and the value (code 20) of driving voltage of the former frame pass through the driving-voltage lookup table 22 for outputting correspondingly a practically-obtained voltage value (code 180);
(4) the first multiplex processing unit 31 receives the selection signal, the minimum overdrive voltage value, the maximum overdrive voltage value and a practically-obtained voltage value (code 180) to thereby output the maximum overdrive voltage value (code 255); the second multiplex processing unit 32 receives the practically-obtained voltage value (code 180) and the value (code 200) of the driving voltage of the present frame to thereby output the practically-obtained voltage value (code 180) according to selection of the selection signal;
(5) the register unit 40 stores the practically-obtained voltage value (code 180) from the second multiplex processing unit 32, and takes the latter as the value of driving voltage of the former frame of the next point of time.

Thereby, to give one of the value of driving voltage of the present frame, the overdrive voltage value, the minimum overdrive voltage value and the maximum overdrive voltage value in pursuance of the requirement of the respectively one of different driving voltages of frames, a liquid crystal display can thus display in a fast and accurate mode.

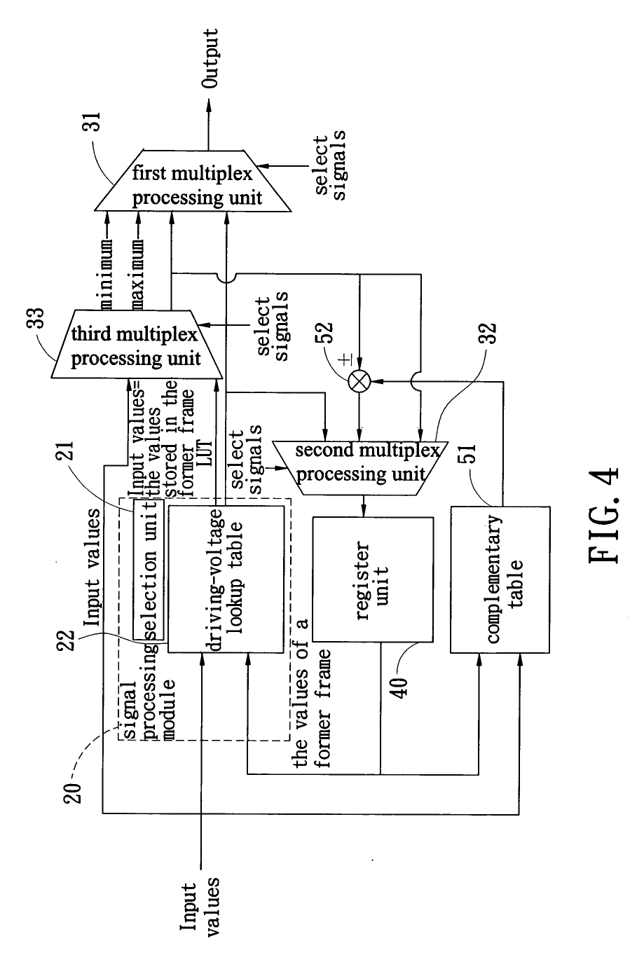

Referring to FIG. 4, the second embodiment of the overdrive method of the present invention is applied to a reaction speed of 8 ms, and includes using: a signal processing module 20 having a selection unit 21 and a driving-voltage lookup table (anti-double edge Lookup Table, namely, ADE LUT) 22, a first multiplex processing unit 31 and a second multiplex processing unit 32 to receive selection signals from the selection unit 21 and values of driving voltages from the driving-voltage lookup table 22, a register unit 40, a complementary table 51, an operation unit 52 and a third multiplex processing unit 33. The values of driving voltages of the present frame are data of 8 bits, the driving-voltage lookup table 22 stores data of 6 bits.

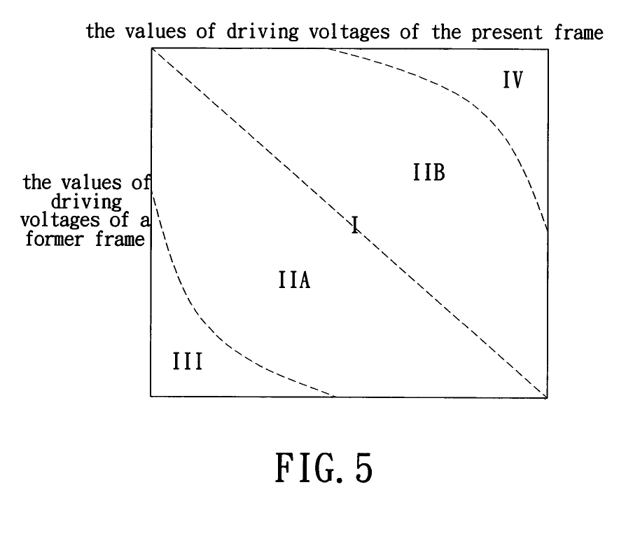

As shown in FIG. 5, two ordinate axes of the driving-voltage lookup table 22 represent the values of driving voltages of a former frame and the values of driving voltages of the present frame. The driving-voltage lookup table 22 has therein a first, a second, a third and a fourth area I, II, III, IV respectively for the values of driving voltages of a former frame and the values of driving voltages of the present frame; wherein the second area II is divided into two sub-areas IIA, IIB, the first area I contains the values of driving voltages of the present frame, the sub-areas IIA, IIB of the second area II contains overdrive voltage values having been complemented, while the third and the fourth areas III, IV contain practically-obtained voltage values.

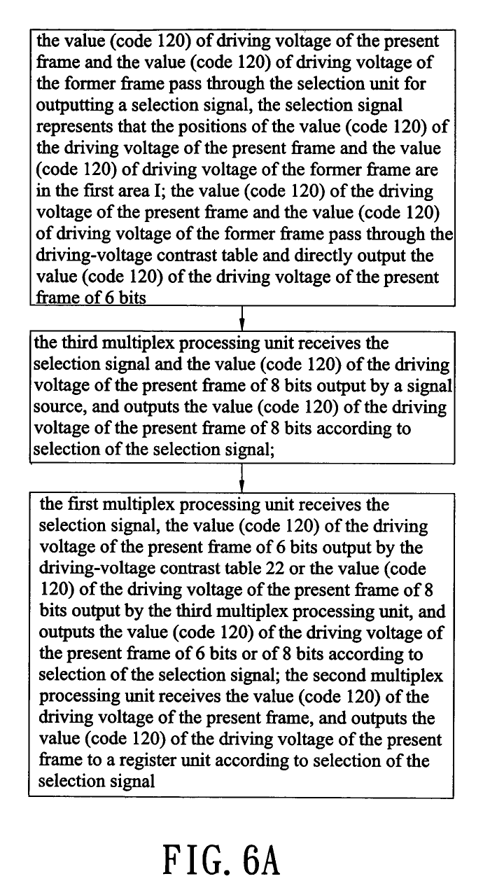

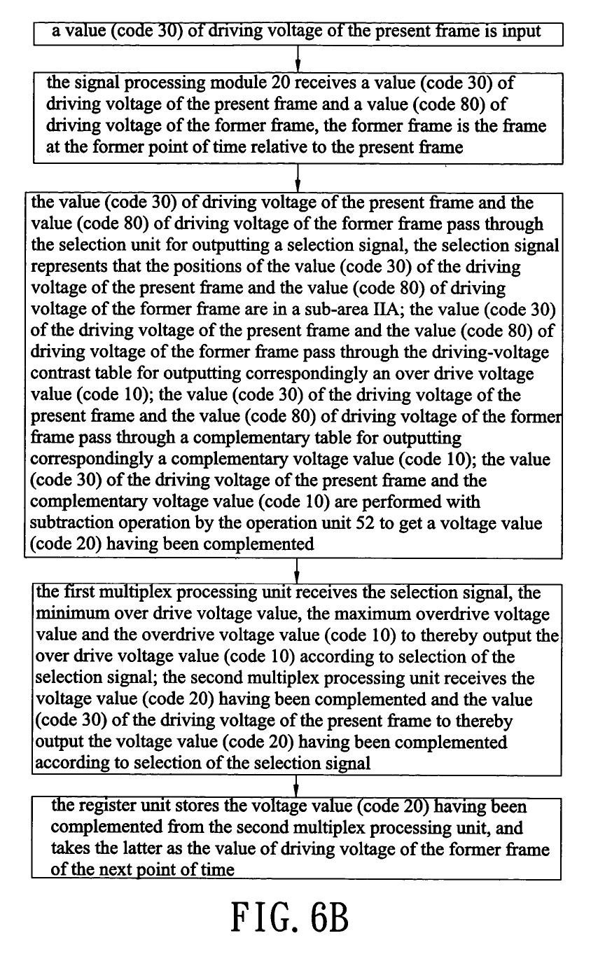

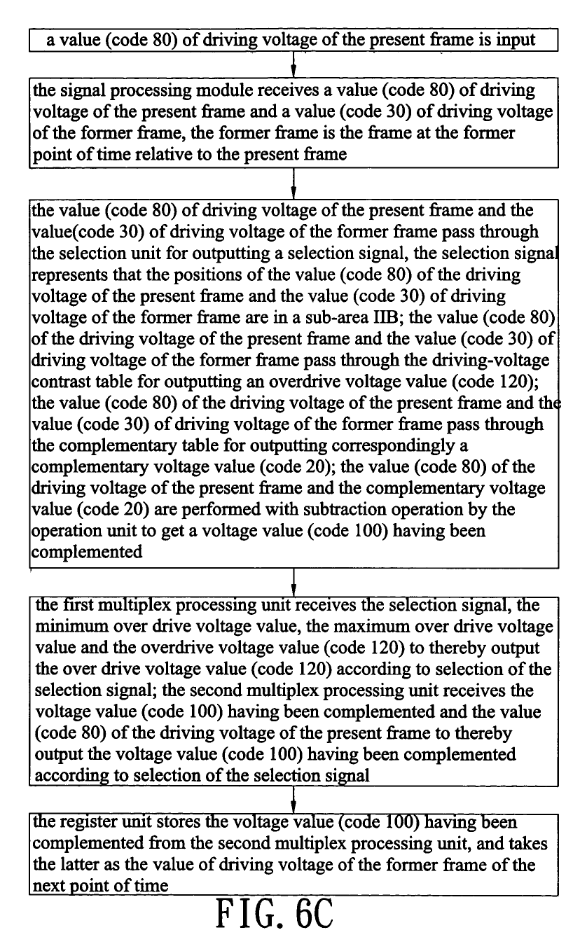

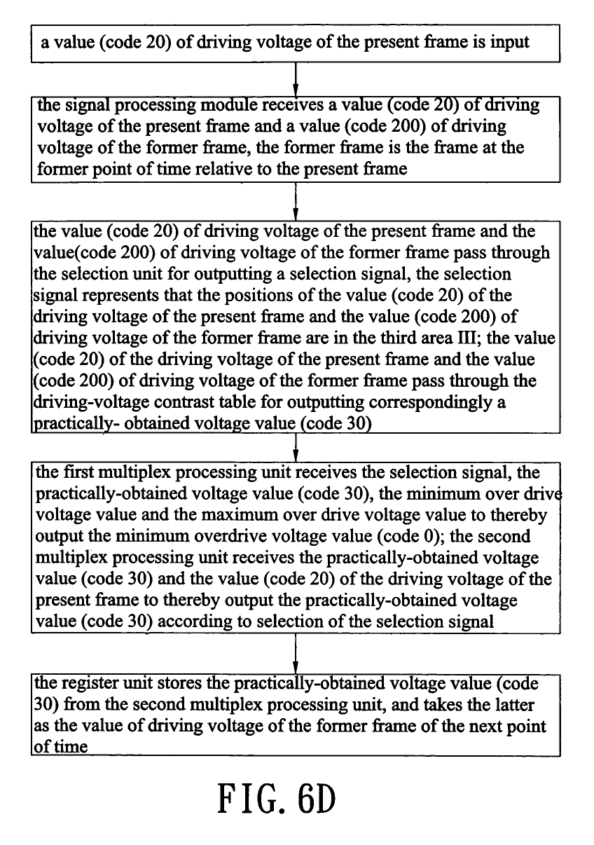

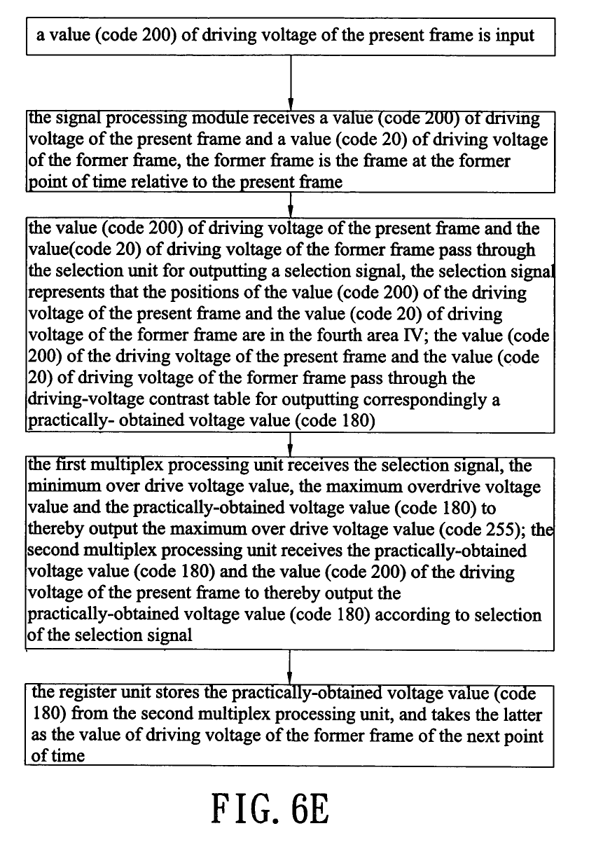

The steps of processing of the overdrive method of the present invention can also include those shown in FIGS. 6A-E, and include five cases:

The first case designates a code 120 (value) of driving voltage of a former frame and a code 120 (value) of driving voltage of the present frame:
(1) the value (code 120) of driving voltage of the present frame and the value (code 120) of driving voltage of the former frame pass through the selection unit 21 for outputting a selection signal, the selection signal represents that the positions of the value (code 120) of the driving voltage of the present frame and the value (code 120) of driving voltage of the former frame are in the first area I; the value (code 120) of the driving voltage of the present frame and the value (code 120) of driving voltage of the former frame pass through the driving-voltage lookup table 22 and directly output the value (code 120) of the driving voltage of the present frame of 6 bits;
(2) the third multiplex processing unit 33 receives the selection signal and the value (code 120) of the driving voltage of the present frame of 8 bits output by a signal source 10, and outputs the value (code 120) of the driving voltage of the present frame of 8 bits according to selection of the selection signal;
(3) the first multiplex processing unit 31 receives the selection signal, the value (code 120) of the driving voltage of the present frame of 6 bits output by the driving-voltage lookup table 22 or the value (code 120) of the driving voltage of the present frame of 8 bits output by the third multiplex processing unit 33, and outputs the value (code 120) of the driving voltage of the present frame of 6 bits or of 8 bits according to selection of the selection signal; the second multiplex processing unit 32 receives the value (code 120) of the driving voltage of the present frame, and outputs the value (code 120) of the driving voltage of the present frame to a register unit 40 according to selection of the selection signal.

The second case designates a value (code 80) of driving voltage of a former frame and a value (code 30) of driving voltage of the present frame:
(1) a value (code 30) of driving voltage of the present frame is input;
(2) the signal processing module 20 receives a value (code 30) of driving voltage of the present frame and a value (code 80) of driving voltage of the former frame, the former frame is the frame at the former point of time relative to the present frame;
(3) the value (code 30) of driving voltage of the present frame and the value (code 80) of driving voltage of the former frame pass through the selection unit 21 for outputting a selection signal, the selection signal represents that the positions of the value (code 30) of the driving voltage of the present frame and the value (code 80) of driving voltage of the former frame are in the sub-area IIA of the second area II; the value (code 30) of the driving voltage of the present frame and the value (code 80) of driving voltage of the former frame pass through the driving-voltage lookup table 22 for outputting correspondingly an overdrive voltage value (code 10); the value (code 30) of the driving voltage of the present frame and the value (code 80) of driving voltage of the former frame pass through the complementary table 51 for outputting correspondingly a complementary voltage value (code 10); the value (code 30) of the driving voltage of the present frame and the complementary voltage value (code 10) are performed with subtraction operation by the operation unit 52 to get a voltage value (code 20) having been complemented;
(4) the first multiplex processing unit 31 receives the selection signal, the minimum overdrive voltage value, the maximum overdrive voltage value and the overdrive voltage value (code 10) to thereby output the overdrive voltage value (code 10) according to selection of the selection signal; the second multiplex processing unit 32 receives the voltage value (code 20) having been complemented and the value (code 30) of the driving voltage of the present frame to thereby output the voltage value (code 20) having been complemented according to selection of the selection signal;
(5) the register unit 40 stores the voltage value (code 20) having been complemented from the second multiplex processing unit 32, and takes the latter as the value of driving voltage of the former frame of the next point of time.

The third case designates a value (code 30) of driving voltage of a former frame and a value (code 80) of driving voltage of the present frame:
(1) a value (code 80) of driving voltage of the present frame is input;
(2) the signal processing module 20 receives a value (code 80) of driving voltage of the present frame and a value (code 30) of driving voltage of the former frame, the former frame is the frame at the former point of time relative to the present frame;
(3) the value (code 80) of driving voltage of the present frame and the value (code 30) of driving voltage of the former frame pass through the selection unit 21 for outputting a selection signal, the selection signal represents that the positions of the value (code 80) of the driving voltage of the present frame and the value (code 30) of driving voltage of the former frame are in the sub-area IIB of the second area II; the value (code 80) of the driving voltage of the present frame and the value (code 30) of driving voltage of the former frame pass through the driving-voltage lookup table 22 for outputting an overdrive voltage value (code 120); the value (code 80) of the driving voltage of the present frame and the value (code 30) of driving voltage of the former frame pass through the complementary table 51 for outputting correspondingly a complementary voltage value (code 20); the value (code 80) of the driving voltage of the present frame and the complementary voltage value (code 20) are performed with subtraction operation by the operation unit 52 to get a voltage value (code 100) having been complemented;
(4) the first multiplex processing unit 31 receives the selection signal, the minimum overdrive voltage value, the maximum overdrive voltage value and the overdrive voltage value (code 120) to thereby output the overdrive voltage value (code 120) according to selection of the selection signal; the second multiplex processing unit 32 receives the voltage value (code 100) having been complemented and the value (code 80) of the driving voltage of the present frame to thereby output the voltage value (code 100) having been complemented according to selection of the selection signal;
(5) the register unit 40 stores the voltage value (code 100) having been complemented from the second multiplex processing unit 32, and takes the latter as the value of driving voltage of the former frame of the next point of time.

The fourth case designates a value (code 200) of driving voltage of a former frame and a value (code 20) of driving voltage of the present frame:
(1) a value (code 20) of driving voltage of the present frame is input;
(2) the signal processing module 20 receives a value (code 20) of driving voltage of the present frame and a value (code 200) of driving voltage of the former frame, the former frame is the frame at the former point of time relative to the present frame;
(3) the value (code 20) of driving voltage of the present frame and the value (code 200) of driving voltage of the former frame pass through the selection unit 21 for outputting a selection signal, the selection signal represents that the positions of the value (code 20) of the driving voltage of the present frame and the value (code 200) of driving voltage of the former frame are in the third area III; the value (code 20) of the driving voltage of the present frame and the value (code 200) of driving voltage of the former frame pass through the driving-voltage lookup table 22 for outputting correspondingly a practically-obtained voltage value (code 30);
(4) the first multiplex processing unit 31 receives the selection signal, the practically-obtained voltage value (code 30), the minimum overdrive voltage value and the maximum overdrive voltage value to thereby output the minimum overdrive voltage value (code 0); the second multiplex processing unit 32 receives the practically-obtained voltage value (code 30) and the value (code 20) of the driving voltage of the present frame to thereby output the practically-obtained voltage value (code 30) according to selection of the selection signal;
(5) the register unit 40 stores the practically-obtained voltage value (code 30) from the second multiplex processing unit 32, and takes the latter as the value of driving voltage of the former frame of the next point of time.

The fifth case designates a value (code 20) of driving voltage of a former frame and a value (code 200) of driving voltage of the present frame:
(1) a value (code 200) of driving voltage of the present frame is input;
(2) the signal processing module 20 receives a value (code 200) of driving voltage of the present frame and a value (code 20) of driving voltage of the former frame, the former frame is the frame at the former point of time relative to the present frame;
(3) the value (code 200) of driving voltage of the present frame and the value (code 20) of driving voltage of the former frame pass through the selection unit 21 for outputting a selection signal, the selection signal represents that the positions of the value (code 200) of the driving voltage of the present frame and the value (code 20) of driving voltage of the former frame are in the fourth area IV; the value (code 200) of the driving voltage of the present frame and the value (code 20) of driving voltage of the former frame pass through the driving-voltage lookup table 22 for outputting correspondingly a practically-obtained voltage value (code 180);
(4) the first multiplex processing unit 31 receives the selection signal, the minimum overdrive voltage value, the maximum overdrive voltage value and the practically-obtained voltage value (code 180) to thereby output the maximum overdrive voltage value (code 255); the second multiplex processing unit 32 receives the practically-obtained voltage value (code 180) and the value (code 200) of the driving voltage of the present frame to thereby output the practically-obtained voltage value (code 180) according to selection of the selection signal;
(5) the register unit 40 stores the practically-obtained voltage value (code 180) from the second multiplex processing unit 32, and takes the latter as the value of driving voltage of the former frame of the next point of time.

Thereby, to give one of the value of driving voltage of the present frame, the overdrive voltage value having been complemented, the minimum overdrive voltage value and the maximum overdrive voltage value in pursuance of the requirement of the respectively one of different driving voltages of frames, a liquid crystal display can thus display in a fast and accurate mode.

The present invention accordingly has the following advantages:
1. It surely can avoid generation of the “Double Edge” phenomenon during image developing: the present invention effectively eliminates the double edge phenomenon generated by liquid-crystal image developing by a plurality of multiplex processing units to select respectively among present frame driving-voltage values, overdrive voltage values and practically-obtained voltage values input from a lookup table and to output driving-voltage values suitable for practical situations.
2. It can largely save the resources of hardware: the present invention comprises using a signal processing module including a selection unit and a driving-voltage lookup table (anti-double edge lookup table, namely, ADE LUT); in comparison with the conventional method, the present invention needs only the storing space of one lookup table, the requirement for the resource of hardware is fewer than that of conventional method; this can largely save the resources of hardware and cost.
3. It outputs suitable values of driving voltage in pursuance of the requirements of different reaction speeds and different situations of liquid-crystal displaying: the present invention is added with a complementary table and an operation unit to give one of the value of driving voltage of a present frame, a voltage value having been complemented, a minimum overdrive voltage value and a maximum overdrive voltage value in pursuance of the requirements of different reaction speeds and different voltages, a liquid crystal display can display in a fast and accurate mode.

The above disclosed are only for illustrating partial embodiments of the present invention, and not for giving any limitation to the scope of the present invention. It will be apparent to those skilled in this art that various modifications or changes without departing from the spirit of this invention shall also fall within the scope of the appended claims.

In conclusion, according to the description disclosed above, the present invention surely can achieve the expected objectives thereof to provide an overdrive method to effectively save the resources of hardware and to eliminate the double edge phenomenon generated at different reaction speeds by selecting respectively among present frame driving-voltage values, overdrive voltage values and practically-obtained voltage values input from a driving-voltage lookup table and by outputting driving-voltage values suitable for respective situations according to selection signals of a selection unit by a plurality of multiplex processing units. The overdrive method is added with a complementary table and an operation unit to meet the requirements of different reaction speeds. Having thus described the technical process of my invention having high industrial value, what I claim as new and desire to be secured by Letters Patent of the United States are:

1. An overdrive method for anti-double edge, said method including:
a signal processing module including a selection unit and a driving-voltage lookup table (anti-double edge LUT, namely, ADE LUT); said driving-voltage lookup table stores data of “n” bits, two ordinate axes of said driving-voltage lookup table represent values of driving voltages of a present frame and values of driving voltages of a former frame; said driving-voltage lookup table has therein a first, a second, a third and a fourth areas that respectively contain part of and are provided for the followings: said values of driving voltages of said former frame, said values of driving voltages of said present frame, overdrive voltage values and practically-obtained voltage values;
a first multiplex processing unit;
a second multiplex processing unit; and
a register unit; wherein
said method comprising the following steps of processing:
(1) a value of driving voltage of said present frame is input, said value of driving voltage of said present frame contains data of “m” bits;
(2) said signal processing module receives a value of driving voltage of said present frame and said value of driving voltage of said former frame, said former frame is a frame at a former point of time relative to said present frame;
(3) said value of driving voltage of said present frame and said value of driving voltage of said former frame are under selection of said selection unit for outputting a selection signal, said selection signal represents one of said first to fourth areas, said value of driving voltage of said present frame and said value of driving voltage of said former frame pass through said driving-voltage lookup table for outputting one of said value of driving voltage of said present frame, an overdrive voltage value and a practically-obtained voltage value;
(4) said first multiplex processing unit receives said selection signal, said value of driving voltage of said present frame, said overdrive voltage value, said minimum overdrive voltage value and said maximum overdrive voltage value to thereby output one of said value of driving voltage of said present frame, said overdrive voltage value, said minimum overdrive voltage value and said maximum overdrive voltage value according to said selection signal; said second multiplex processing unit receives one of said selection signal and said value of driving voltage of said present frame, said overdrive voltage value and said practically-obtained voltage value to thereby output one of said value of driving voltage of said present frame and said practically-obtained voltage value according to selection of the selection signal; and
(5) said register unit stores one of said value of driving voltage of said present frame, said overdrive voltage value and said practically-obtained voltage value output from said second multiplex processing unit, and takes said output as said value of driving voltage of said former frame of a next point of time to output to said signal processing module;
thereby, to give one of said value of driving voltage of said present frame, said overdrive voltage value, said minimum overdrive voltage value and said maximum overdrive voltage value in pursuance of the requirement of respectively one of different driving voltages of frames, a liquid crystal display displays in a fast and accurate mode.

2. The overdrive method for anti-double edge as in claim 1, wherein: said first area contains values of driving voltages of said present frame, said second area contains overdrive voltage values, while said third and said fourth areas contain practically-obtained voltage values.

3. The overdrive method for anti-double edge as in claim 1, wherein: said number “n” is smaller than or equals to said number “m”.

4. The overdrive method for anti-double edge as in claim 1, wherein: said method further uses a complementary table and an operation unit; said value of driving voltage of said present frame and said value of driving voltage of said former frame pass through said driving-voltage lookup table for outputting a voltage complementary value, said operation unit does operation with said voltage complementary value for said value of driving voltage of said present frame, then said operation unit obtains a voltage value having been complemented; said first multiplex processing unit receives said selection signal, said value of driving voltage of said present frame, said overdrive voltage value, said minimum overdrive voltage value and said maximum overdrive voltage value to thereby select to output one of said value of driving voltage of said present frame, said overdrive voltage value, said minimum overdrive voltage value and said maximum overdrive voltage value according to said selection signal; said second multiplex processing unit receives said selection signal, said value of driving voltage of said present frame, said voltage value having been complemented and said practically-obtained voltage value to thereby select to output one of said value of driving voltage of said present frame, said voltage value having been complemented and said practically-obtained voltage value.

5. The overdrive method for anti-double edge as in claim 1, wherein: said method further uses a third multiplex processing unit located between said signal processing module and said first multiplex processing unit; said third multiplex processing unit receives said selection signal input from said signal processing module and said driving voltage of said present frame input from a signal source, and outputs said value of driving voltage of said present frame directly to said first multiplex processing unit according to selection of said selection signal.

6. The overdrive method for anti-double edge as in claim 4, wherein: said method further uses a third multiplex processing unit located between said signal processing module and said first multiplex processing unit; said third multiplex processing unit receives said selection signal input from said signal processing module and said driving voltage of said present frame input from a signal source, and outputs said value of driving voltage of said present frame directly to said first multiplex processing unit according to selection of said selection signal.

7. The overdrive method for anti-double edge as in claim 1, wherein: said multiplex processing units are multiplexers.

8. The overdrive method for anti-double edge as in claim 5, wherein: said multiplex processing units are multiplexers.
